(19) United States
(12) Patent Application Publication
(10) Pub. No.: US 2003/0020994 A1
(43) Pub. Date: Jan. 30, 2003

(54) Optical system and method in an optical system

(76) Inventor: Lars Boden, Bromma (SE)

Correspondence Address: FOLEY AND LARDNER, SUITE 500, 3000 K STREET NW, WASHINGTON, DC, 20007, US

(21) Appl. No.: 10/193,673

(22) Filed: Jul. 12, 2002

Related U.S. Application Data
(60) Provisional application No. 60/305,296, filed on Jul. 13, 2001.

(30) Foreign Application Priority Data
Jul. 13, 2001 (SE) 0102524-6

(51) Int. Cl. H04J 14/02; H04B 10/12

(52) U.S. Cl. 359/173; 359/127

(57) ABSTRACT

Present invention relates to an optical communication system, a method, and the use of a network module in an optical communication system. The optical communication system comprises a network having at least one optical fiber 22. The total bandwidth of each fiber is divided into a number of wavelength bands. Each wavelength band has a channel, λ₁-λₙ, being able to carry information. The optical system according to the invention is characterised in that channels are interleaved for counter-directional transmission, wherein information is transmitted on a channel in one direction, while information on adjacent channels on the same fiber is transmitted in the opposite direction. Thus, a method for transmitting information over an optical communication system according to the present invention comprises the step of transmitting information on one channel in one direction, while information on adjacent channels on the same fiber is transmitted in the opposite direction. The invented method and system have one advantage in that it suppresses the cross talk effect between adjacent channels.

### TECHNICAL FIELD

Present invention relates to an optical communication system, a method, and the use of a network module in an optical communication system. More specific, the invention relates to a Counter Directional Optical System and implementation method in a WDM optical system for cross-talk optimisation.

### BACKGROUND OF THE INVENTION

The growth of the amount of traffic exchanged over the major backbone systems crisscrossing the world is a phenomenon we are well accustomed to. A very efficient doctrine was formulated to tackle the problem: Wavelength Division Multiplexing, WDM. It consists in increasing the information capacity on the same fibre by juxtaposing a number of channels at different wavelengths. The closer the wavelengths are spaced the larger the amount of information transmitted. As the shortage in capacity became more and more severe, wavelength channels were packed closer and closer, giving birth to the Dense WDM (DWDM) technology. In order for DWDM to work, it is essential that the different channels don't interfere with each other. This becomes increasingly difficult, as the channels are closer together: it is called incoherent cross-talk. To solve the problem, all critical components (lasers, filters) must be temperature stabilized and mounted in a thermal packages. This makes the DWDM components very expensive. It is the development of Erbium Doped Fiber Amplifiers (EDFAs) that made the DWDM solution economically interesting in certain situation. It allowed the transfer of vast amount of information over long distances. The amplifiers are expensive, but the added cost relative to the overall cost of a system is small. This solution doesn't come cheap, but the cost of the alternative—breaking new ground or laying new fibre at the bottom of the ocean—makes it much preferable.

In a metropolitan environment, the problem is different. To start with, bandwidth bottleneck is more recent: traditional copper-based or simpler fibre-based solutions were thought to be able to cope with the growing traffic for the foreseeable future. As a result, very little thought was given to the development of a strategy specifically targeted at the Metropolitan Bandwidth Bottleneck. When the realization dawned that traffic growth was outpacing bandwidth availability, the first move was to adopt a scaled-down version of the proven DWDM technology. However some discrepancies became rapidly apparent. The requirements of information distribution in a metropolitan environment impose very flexible networks, with many distribution nodes. Besides, all channels may not be terminated at the same node. This complexity usually means increased optical losses, since each node adds its insertion loss to the system. The problem is that, contrary to long-haul WDM, the metropolitan market is very cost averse, which means that EDFA is not really an option. Moreover, the dynamics of EDFA increases the difficulty of system management, a major challenge in systems already complex. To make things worse, many of the costs associated with long-haul Dense WDM systems can't really be scaled down, even if the system capacity is. The laser sources are still very expensive due to the requirement of wavelength stability with temperature. The design of the passive filters is a tricky balancing act between channel isolation and insertion losses, with the extra demand on the materials and construction to ensure temperature stability. Lastly the bandwidth demand of most major metropolitan distribution networks, although it is growing, is nowhere near the amount of traffic DWDM was meant to address. Clearly, the DWDM coat is much too large and too expensive for most of the metropolitan market.

A different approach is needed to formulate a strategy native to metropolitan market, combining the following characteristics:

Smooth bandwidth upgrade path

Flexible number of distribution nodes

Optical transparency allowing for a seamless transition from the older type of data traffic (legacy protocols)

No amplifiers

Good level of protection

Low cost

A new concept emerged from these requirements and was described in a previous Swedish patent application: SE0101416-6[1]. This strategy addresses all the points mentioned above. As in the DWDM case, bandwidth is increased by adding new wavelengths, or channels. According to this new concept, these channels are 20 nm apart, instead of a fraction of nanometer. For instance, the wavelengths may be fixed at 1470 nm, 1490 nm, 1510 nm, 1530 nm, 1550 nm, 1570 nm, 1590 nm and 1610 nm. In this example 8 channels are defined, but it is no problem to increase the number of channels, if the total bandwidth allows more channels. This means that the requirements on wavelength control are greatly relaxed, which decreases the price of the active components. The specification on the passive filters, such as OADM (Optical Add Drop Multiplexers) filters, can be relaxed as well.

A standard OADM may be designed as a thin-film filter based on a small piece of crystal coated by a number of layers of material, creating a selective mirror. Using this property, it is possible to reflect a wavelength band from a light beam propagating through the crystal. Conversely, according to the reverse path ray law, it is also possible to add this wavelength band. It is possible to increase the isolation between reflected and transmitted channels, either by cascading two isolation filters or by improving the design of the filters and selecting them. In the first case, the total insertion losses are increased as well as the price because there are more components involved. In the second case, the yield goes down pushing up the price. At present, the OADM are constituted of series of two thin-film filters: one to drop a channel from the ring, and the other to add the same channel back into the ring.

In the solution proposed in [1], each channel supports a logical ring, with a number of OADM, which means that the ring can be accessed at many points. At the same time, each OADM adds its insertion loss to the overall power budget of the network. Protocols are determined by end-user equipment with no effect on the performances of the system. The ring structure offers a good level of protection, and the costs for CWDM (Coarse WDM) are typically much lower than the cost of a corresponding DWDM system.

A major constraint in the design of an optical system is the isolation of the different channels propagating through the OADMs. In the case of CWDM, the channels are typically 20 nm away from each other. This means that as far as isolation is concerned the contribution of any channel other than direct neighbor is negligibly small. If isolation is too low, then some light from a neighboring channel is dropped at an OADM along with the wavelength meant for this node. In the worst case, if the signal is already weak, then the parasitic light from the neighboring channel can cause serious perturbation at the detector (incoherent cross-talk).

Another critical parameter is the insertion loss of the various passthrough OADM that all the channels have to go through between two Add-Drop nodes of their own. If those losses are too large, the span of the ring has to be reduced, in order to avoid the use of amplifiers. Alternatively, the number of pass-though OADM must be decreased, which reduces the flexibility of the Add/Drop configuration. The challenge is to balance isolation and insertion loss such as to optimize the reach of the system while suppressing cross talk.

The most common way to solve the problem is to cascade two filters, or more. High values of isolation can be reached because the total isolation is the sum of the isolation of all individual filters. However, the insertion losses are also added. This doesn't really matter in the case of DWDM, because amplifiers are usually allowed. In the case of metropolitan CWDM systems, as described earlier, amplifiers are not economical. This means that extra insertion loss is very detrimental.

### BRIEF DESCRIPTION OF THE INVENTION

The present invention describes an optical communication system, a method, and the use of a network Add/Drop module in an optical communication system.

It is therefore an object of the present invention to provide a method for transmitting information over an optical communication system and an optical communication system. Said invented method and system suppress the crosstalk effect between adjacent channels, improve the isolation of the different channels propagating through the OADMs and improve the insertion loss of the various pass-through OADM that all the channels have to go through between two Add-Drop nodes of their own.

This object is achieved according to the invention in that adjacent channels are counter-propagating. A system based on this pattern of traffic is made possible by way of using a counter-directional optical Add/Drop Multiplexer module, according to the invention.

One advantage of a method and system according to the invention is that it provides a more effective and more cost-effective suppression of the cross talk effect between adjacent channels than the prior art.

Further one advantage is that the design of the Add/Drop module allows for a relaxation of the requirements on isolation for the filters composing it. This in turn can have positive effects on the insertion loss of the filters.

### BRIEF DESCRIPTION OF THE DRAWINGS

The present invention will be described in more detail in connection with the enclosed drawings.

FIG. 1 is a schematic illustration of an optical communication network system for optical transmission of information.

FIG. 2 is a schematic illustration of the channel directions and distribution in an optical communication network system according to the present invention.

FIG. 3 depicts the principle of a network Add/Drop module in an optical communication system according to the present invention.

FIG. 4 is a more detailed illustration of a network Add/Drop module in an optical communication system according to the present invention.

FIG. 5 is a schematic illustration of an optical communication system according to prior art.

FIG. 6 is an optical signal diagram showing the theoretical distribution of different channels and the signal optical power on each channel in an optical communication system.

FIG. 7 is an optical signal diagram illustrating the crosstalk effect on adjacent channels in an optical communication system according to prior art.

FIG. 8 is a schematic illustration of the crosstalk effect of a neighbouring channel in a network Add/Drop module in an optical communication system according to the present invention.

FIG. 9 is an optical signal diagram illustrating the crosstalk effect on adjacent channels in an optical communication system according to present invention.

FIG. 10 is a schematic illustration of a multiplexed ring structure.

FIG. 11 is an illustration of a logical ring structure.

FIG. 12 is an illustration of a logical ring structure of a Hybrid CWDM-DWDM system, which is further one embodiment of the present invention.

FIG. 13 is a spectrum diagram for a transmission system based on the Hybrid CWDM-DWDM system technology, as disclosed in FIG. 12.

The present invention will become more fully understood from the detailed description given hereinbelow and the accompanying drawings, which are given by way of illustration only and thus are not to be considered as limiting the present invention.

### DETAILED DESCRIPTION OF THE INVENTION INVENTION

In the following, the Swedish patent application SE0 101416-6 is denoted [1]. The content of the mentioned application is hereby fully integrated by way of reference.

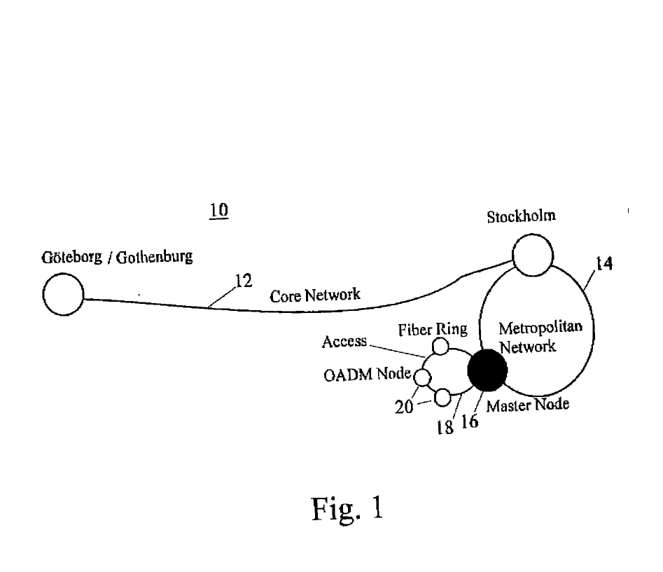

FIG. 1 is a schematic illustration of a system 10 for optical transmission of information, wherein said system comprises an optical fibre network. Said network is arranged between two geographic sites, e.g. Gothenburg and Stockholm. This long distance part of the system is called a core network 12, sometimes even called a backbone. The core network includes a trunk of optical fibres for the transmission of information. From the core network 12 is the information conducted into a metropolitan access network (MAN) ring 14. At least one master node 16 is connected to said MAN. The master node 16 is a common node for the MAN 14 and an access ring 18. The access ring 18 may comprises at least one optical fibre. Connected to said fibre is a series of OADM nodes 20. Subscriber/client devices for receiving and/or transmitting information are connected to each OADM-node via subscriber/client connections.

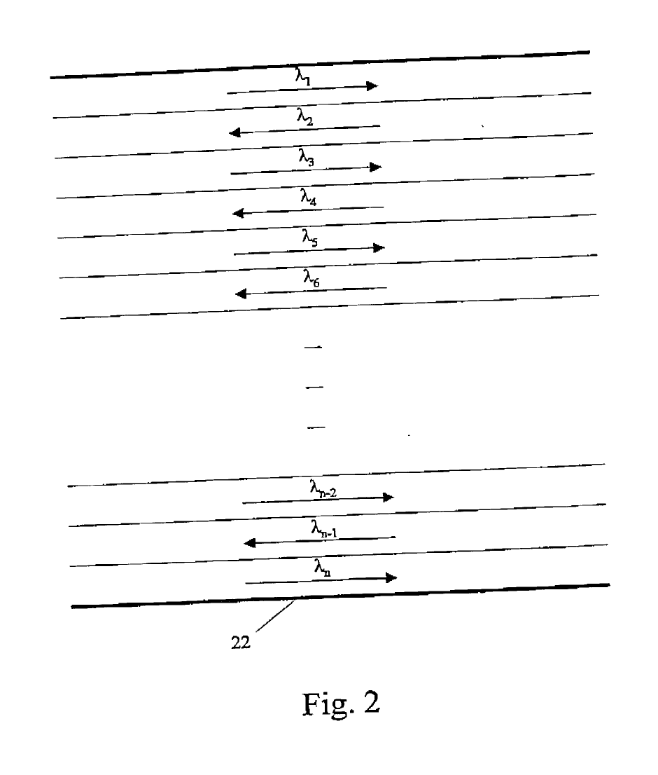

FIG. 2 is a schematic illustration of the channel directions and distribution in an optical communication network system according to the present invention. The optical communication system comprises a network having at least one optical fibre 22. The total bandwidth of each fibre is divided into a number of wavelength bands. Each wavelength band has a channel, λ₁-λₙ, being able to carry information. With exception for the lowest channel λ₁ and the highest channel λₙ, all of the channels have two adjacent channels as closest neighbours. For instance, channel λ₂ has two adjacent channels λ₁ and λ₃, but λ₁ has only one, λ₂. In a fibre in the invented optical system, illustrated in FIG. 2, channels are interleaved for counter-directional transmission. Information on “odd” channels (λ₁, λ₃, . . . ) are transmitted in one direction, while information on adjacent “even” channels (λ₂, λ₄, . . . ) on the same fibre is transmitted in the opposite direction. Thus, a method for transmitting information over an optical communication system according to the present invention comprises the step of transmitting information on a channel in one direction, while information on adjacent channels on the same fibre is transmitted in the opposite direction. The invented method and system have one advantage in that it suppresses the crosstalk effect between adjacent channels, because the optical power that is conducted away from the adjacent channels is reduced considerably.

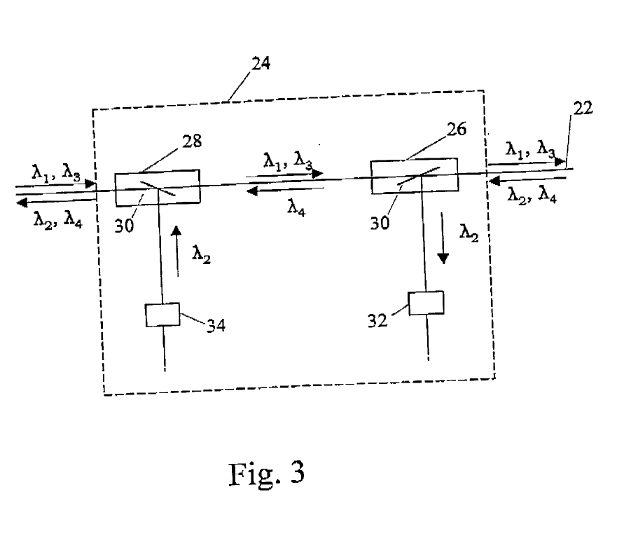

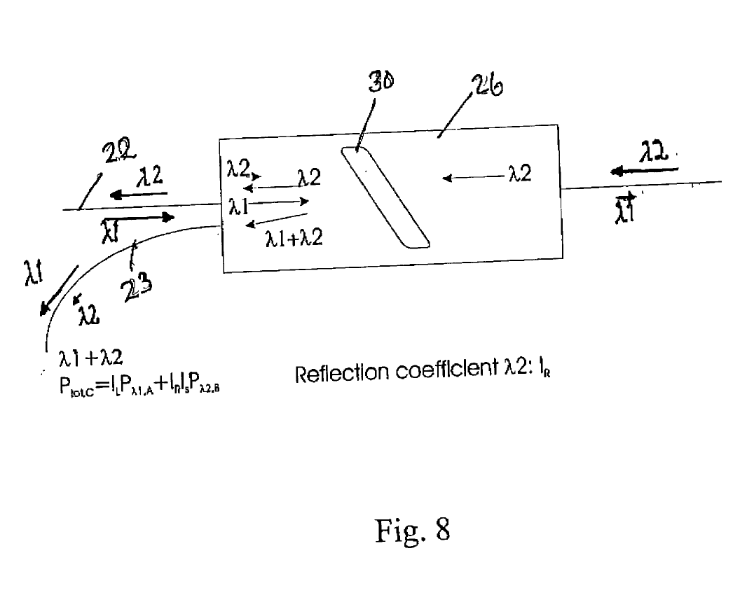

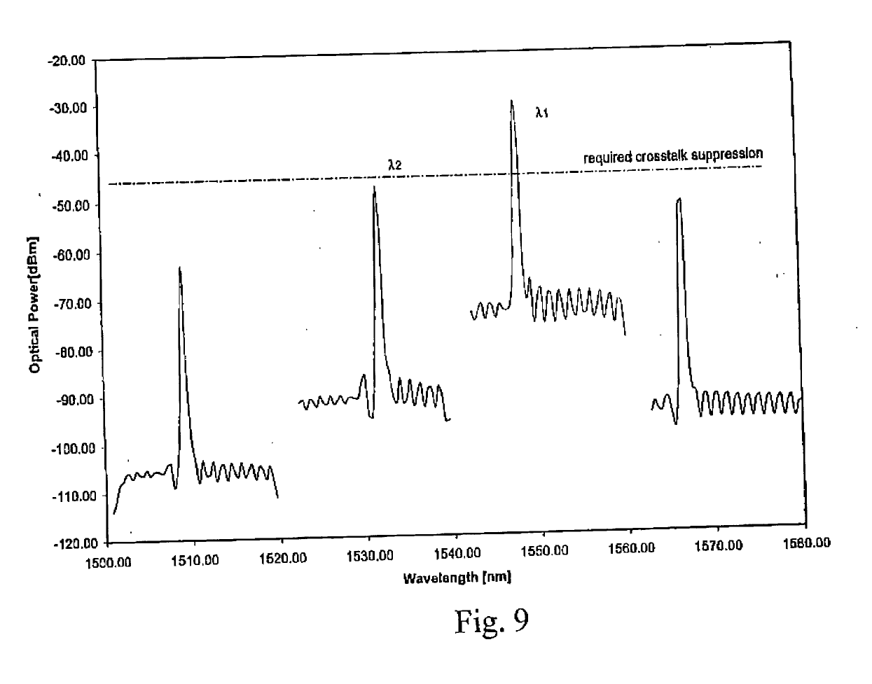

FIG. 3 is a schematic illustration of a counter-directional Optical Add/Drop Multiplexer module 24 in an optical communication system 10 according to the present invention. The module 24 comprises two optical add/drop filters 26 and 28, one filter 26 for dropping the information on one of the channels, e.g. λ₂, and one filter 28 for adding information back to the same channel on the fibre 22. Information is added or dropped by a mirror element 30 in the filters, which mirror element is adapted for a certain optical wavelength of a chosen channel. The information that is dropped by means of the dropping filter 26 will be conducted to a receiver 32. The mirror element 30 is more or less transparent for the other wavelengths of the channels of the fibre 22 than the predetermined channel. It is less transparent for the closest optical wavelengths. In other words, the adjacent channels are less isolated from the predetermined channel than the more distant channels. However, the isolation is improved considerably by directing the information on the adjacent channels, e.g. λ₁ and λ₃, in the opposite direction relatively to the intermediate channel, λ₂, in a system according to the invention. This advantage over prior art will be more described further down in connection to FIGS. 8 and 9. Some of the optical power of the adjacent channels will be lost and dropped when passing the adding multiplexer 28, but this optical power will not cause any trouble as it is conducted to the output of a transmitter 34. The transmitter 34 is able to add information, that means transmit information, on a predetermined channel.

As presented in our examples, the filters can be based on thin-film, but other technologies, such as fused couplers, can also be used, since the relations between isolation and insertion loss are general to filter theory. A standard OADM may be designed as a thin-film filter based on a small piece of crystal coated by a number of layers of material, creating a selective mirror. Using this property, it is possible to reflect a wavelength band from a light beam propagating through the crystal.

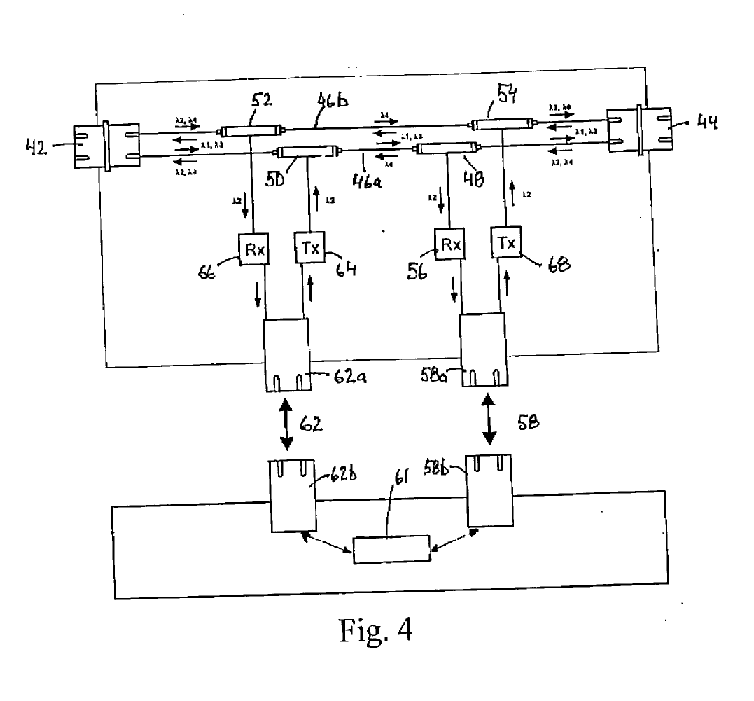

In the case of [1], the system is based on a fibre pair. An OADM for this type of system is then formed by two such network elements in parallel, as shown in FIG. 4.

FIG. 4 is an embodiment of a counter-directional Optical Add Drop Multiplexer module 40 in an optical communication system 10 according to the present invention. This optical add/drop multiplexer (OADM) 40 is arranged in a node of a network of the system 10. The multiplexer 40 is connected to a fibre pair 46a, 46b of the access ring (18 in FIG. 1) via the contact interfaces, east 42 and west 44. Information is transported in both directions on the pair. The module 40 comprises four optical add/drop filters 48, 50, 52, 54, one filter 48 for dropping the information on one of the channels, e.g. λ₂, of one 46b of the fibres and one filter 50 for adding information back to the same channel on the same fibre 46b. The module 40 also comprises two receivers 56, 66 and two transmitters 64, 68, one client west interface 58 and one client east interface 62 and an information processing unit 60 having a processor 61.

The function of the OADM 40 is following. The present node drops λ₂-channel information of the fibre pair 46a, 46b. The information of the λ₂-channel on the fibre 46a is dropped by means of the drop-filter 48. Said information is conducted to a receiver 56 that forwards the information to a low cost transceiver 58a of the client west interface 58 to a low cost transceiver 58b of a processing unit 60. Each transceiver 58a, 58b, 62a, 62b is an optical connection or an electric interface to a processing unit 60 that comprises an information processor 61 being able to process said dropped information. The information is returned via the low cost transceiver 62b of the information processing unit 60, over the client east interface 62 to a corresponding transceiver 62a. A transmitter 64, which is connected to the transceiver 62a, transmits the information on to the λ₂ channel by means of the add-filter 50 onto the same channel λ₂ and the same fibre 46a.

On the corresponding way, the information of the λ₂-channel on the fibre 46b is dropped by means of the drop-filter 52. Said information is conducted to a receiver 66 that forwards the information to the low cost transceiver 68a of the client east interface 62 to a low cost transceiver 62b of the processing unit 60. The information is returned via the low cost transceiver 58b of the information processing unit 60, over the client west interface 58 to a corresponding transceiver 58a. A transmitter 68, which is connected to the transceiver 58a, transmits the information on to the λ₂-channel by means of the add-filter 54 onto the same channel λ₂ and the same fibre 46b.

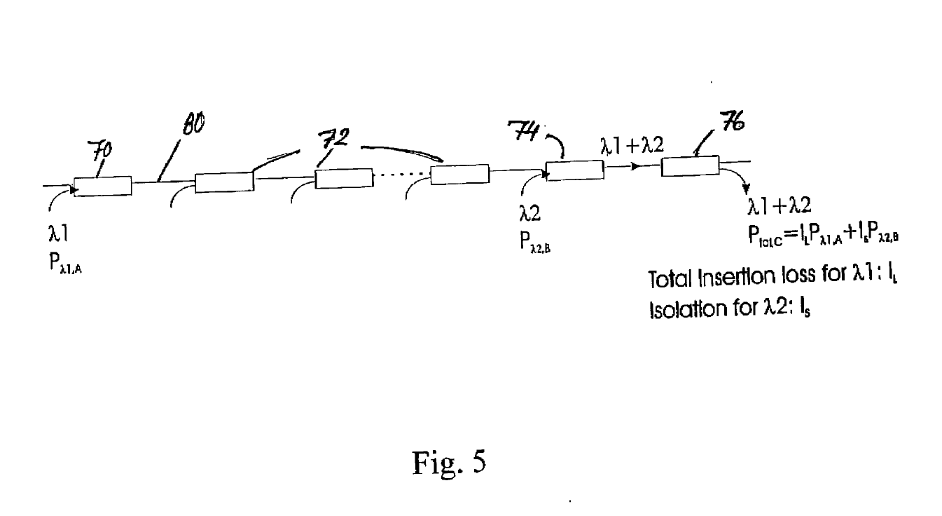

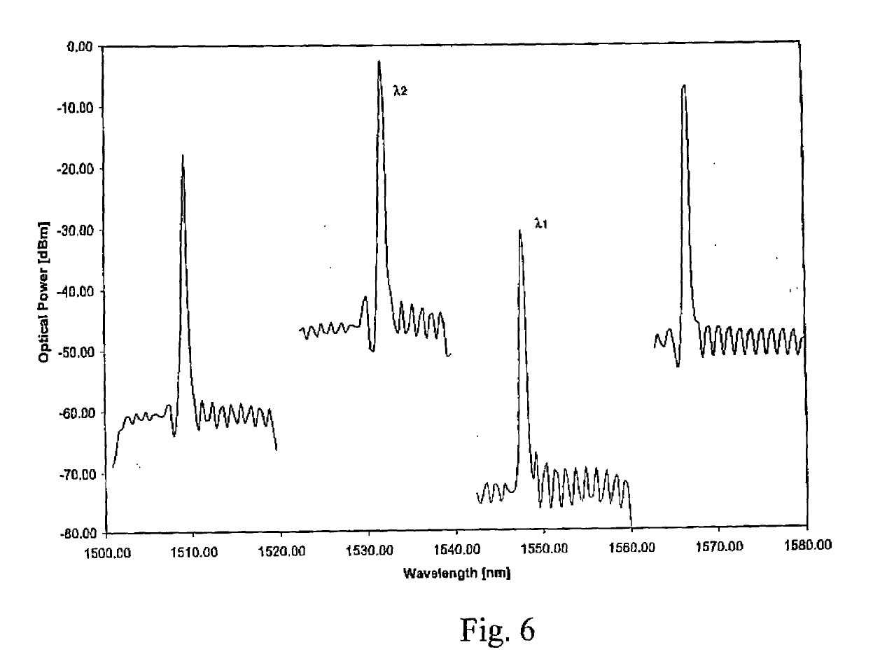

The advantages of the present invention over prior art systems will now be described by means of FIGS. 5-9. Each FIG. 6, 7 and 9 shows one diagram wherein the abscissa is the optical wavelength, λ [nm], and the ordinate is the optical power [dBm]. In a transmission system based on the CWDM (coarse-wavelength-division-multiplexing) technology a number of optical transmission bands are spread in a band of the optical spectrum. FIG. 6, 7 and 9 show four optical transmission bands, each one including one channel, λₙ (n=1, 2, 3, 4, . . . ). Different wavelength channels are separated for not interfering with each other. A typical channel spacing is 20 nm (corresponding to 2400 GHz in the frequency band). FIG. 8 is a schematic illustration of a drop-filter 26 comprising a mirror element 30 and a output optical fibre 23. The filter 26 is connected to an optical fibre 22 and the mirror element is adapted for dropping a channel λ1, which is adjacent to channel λ2. All or almost all optical power of λ1 that is received by the filter 26 will be dropped and further conducted through the output conductor 23. According to the invention, λ2 is counter-propagating to λ1 and therefore only a small fraction of the received optical power will be lost due to reflection. This loss is far less than the loss, if channel λ2 had been co-propagating with λ1. The whole optical power dropped by filter 26 is denoted P_{tot,C}. This output power is defined and calculated as

P_{tot,C}=I_{L}·P_{λ1,A}+I_{R}·I_{S}·P_{λ2,B,} wherein

the coefficient I_{L} is the insertion loss, the reflection coefficient I_{R} is the loss due to reflection and I_{S} is the isolation loss in the filter. The result and advantages of the invented method and system will be discussed further down and a resulting spectrum is shown in FIG. 9.

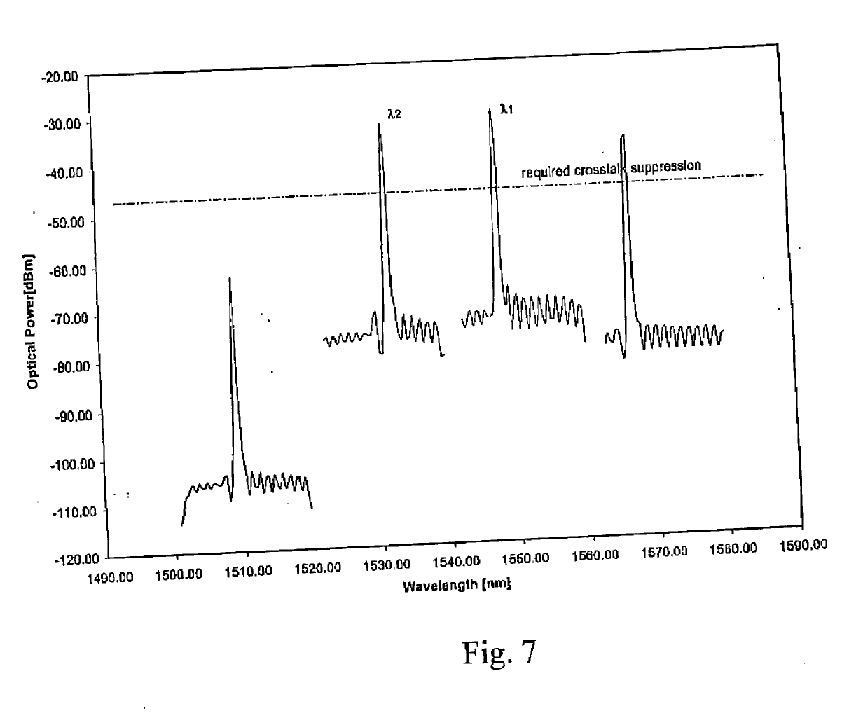

FIG. 5 illustrates a section of a fibre ring 80, for instance an access ring, of an optical communication system according to prior art. At a node 70, information having an optical power P_{λ1,A} is added onto a channel λ₁. This information will be transmitted to a node 76, probably situated a long distance from node 70. On its way to node 76, the information will probably pass a great number of intervening nodes 72 and 74. The information will lose some of its optical power at every node 72 and 74 before reaching node 76. At a node 74, information having an optical power P_{λ2,B} is added onto a channel λ₂ of the same fibre. As said earlier, in the case of CWDM, one only has to take into account cross talk between neighboring channels. In the case shown in FIGS. 5-7, λ1 has a power budget equal to 30 dB (I_{L}=−30 dB). Making the assumption that P_{λ1,A}=P_{λ2,B}, the isolation for λ_{2, I}_{S}, has to be equal to 45 dB in order to guarantee a suppression of 15 dB of λ2 relative to λ1. The spectrum of the light just before the OADM is shown in FIG. 6. In this drawing, λ1 is around 1550 nm, and λ2 is around 1530 nm. λ1 is very weak, due to insertion loss, whereas λ2 is strong. FIG. 7 shows what happens in the case of a single stage filter, with an isolation of 30 dB. The signal at λ1 is barely stronger than the parasitic channel at λ2. As explained earlier, due to insertion loss, concatenating two filters is not optimal.

If however λ2 is counter-propagating to λ1, as shown in FIG. 8, the contribution of λ2 to the total output at the drop port is indirect through a first reflection of the termination of the filter. The resulting spectrum is shown in FIG. 9. If the reflection is at a glass/glass junction, I_{R}=−30 dB. If it is a glass/air, I_{R}=−15 dB. This means that the effective isolation, I_{R}*I_{L}, is between 45 dB and 60 dB even in the case of a single filter. In effect, this removes the constraint on isolation in thin-film design for CWDM without degrading insertion loss. The difference between λ1 and λ2 is now more than 15 dB, and the cross talk problem is avoided.

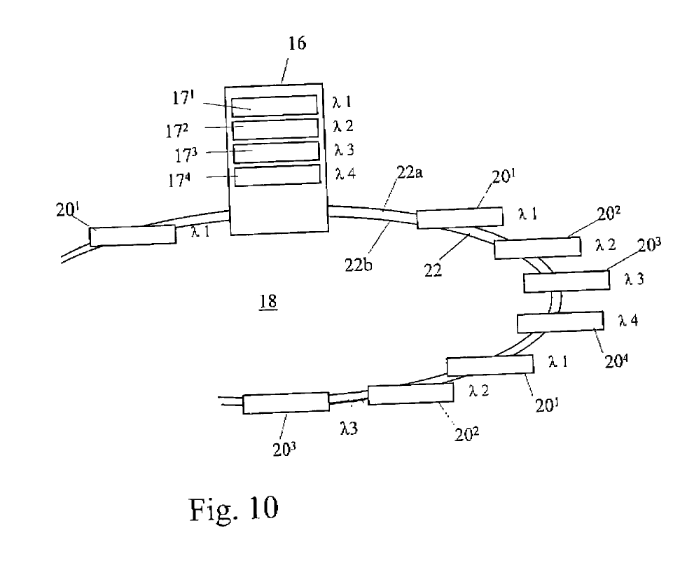

FIG. 10 is a schematic illustration of a multiplexed ring structure according to the invention. In this embodiment an access ring 18 comprises two optical fibres 22a, 22b constituting a fibre pair 22. A number of nodes 20, of which one is the master node 16, are connected to said ring 18 and fibre pair 22. The master node 16 connects the access ring 18 to a metropolitan area network, MAN 14. All nodes are physically connected to one fibre or a fibre pair, but logically the nodes are connected to different logical rings/channels λₙ (n=1, 2, 3, 4, . . . ). This means that physically adjacent OADM-nodes, in other words neighbour nodes, do not need to be logical neighbours. A master node is characterised as a common point for all logical rings and it therefore allows transfer of information from one logical ring to another. One Master node 16 is created by cascading a number of nodes, each belonging to one of the rings intersecting the Master node 16. Each Master node element 17¹, 17², 17³, 17⁴ feeds one wavelength in the next Master node element, which add a new wavelength, until all the desired wavelengths are multiplexed.

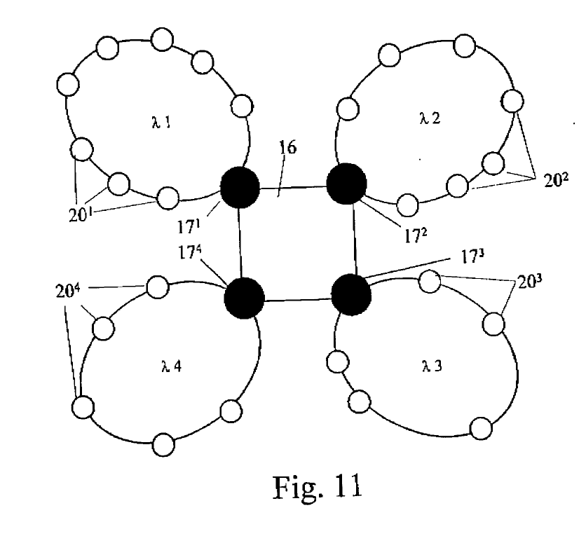

FIG. 11 is an illustration of a logical ring structure according to the present invention. This embodiment provides a multiplexed ring structure combining a number of logical optical rings on the same physical fibre ring. Each logical ring operates on a different wavelength band. Each ring is constituted by a series of OADM nodes, such as one wavelength is dropped and/or added, while the other wavelengths go through with minimum cross talk. Each node retrieves all traffic at the wavelength defining the logical ring it belongs to. Depending on the situation, the traffic then can be either terminated or fully regenerated and/or processed and then sent back into the logical ring. All logical rings have at least one common point called Master or a Master node. This Master node 16 intersects all logical rings and allows to transfer traffic from one ring to the other, by converting the wavelength. It acts as well as a gateway between the multiplexed logical rings and a larger core system, for instance a Wide Area Network (WAN) or a Metropolitan Area Network (MAN). As in FIG. 10, one Master node 16 is created by cascading a number of nodes 20¹, 20², 20³, 20⁴, each belonging to one of the rings λ1, λ2, λ3, λ4 intersecting the Master node 16. Each Master node element 17¹, 17², 17³, 17⁴ feeds one wavelength in the next Master node element, which add a new wavelength, until all the desired wavelengths are multiplexed.

The difference between this and other network structure is following. Compared to only TDM rings the maximum number of access nodes is now increased by a multiple with the number of wavelength used in the network. Each wavelength access node is communicating with the neighbour with the same wavelength, not with the physical/geographical neighbour. Compared to WDM hubbed rings the logical traffic pattern flow is still existing.

As suggested in [1], one of the CWDM channel might be replaced by a number of DWDM channels, all encompassed in the tolerance of the corresponding CWDM band. According to another embodiment of the invention, these DWDM channels would then all be co-propagating, but counter-propagating to the adjacent CWDM bands. A CWDM band is defined as the wavelength slot extending 13 nm around the central wavelength as defined by the CWDM grid.

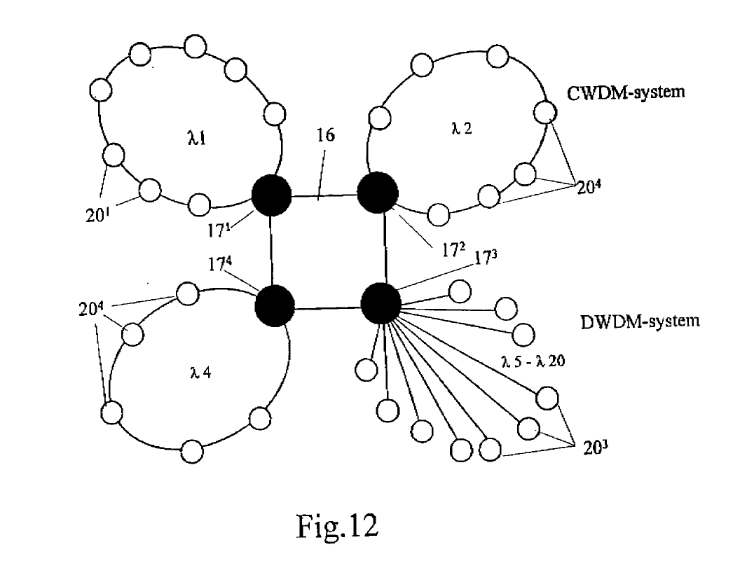

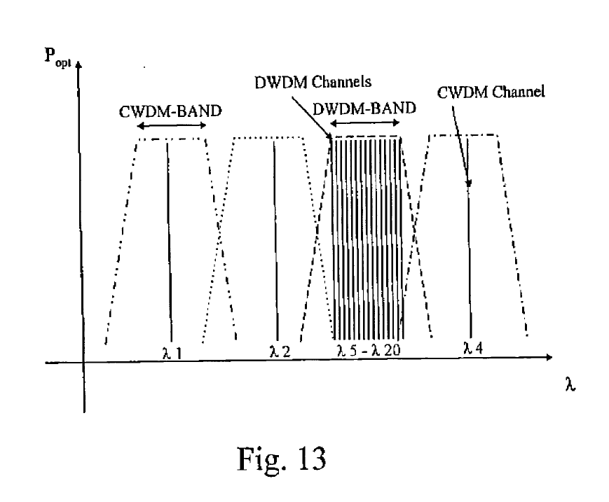

FIG. 12 is an illustration of a logical ring structure of a Hybrid CWDM-DWDM system, which is further one embodiment of the present invention. Due the fact that CWDM channels use a wavelength band with a bandwidth of around 13 nm, it is possible to build a hybrid system. One of the channel bands is used for a multi-channel DWDM system, in this case 16 (λ₅-λ₂₀). The add/drop configuration of the DWDM system then would be a hubbed configuration and thus some nodes with an extraordinary need of broadband access could be supplied by this system. The DWDM system has no logical ring structure and acts as point-to-point structure from the master 16 to node 20. This will constitute a hybrid system that can have a spectrum diagram illustrated in FIG. 13.

In FIG. 13 is a spectrum diagram illustrated, wherein the abscissa is the optical wavelength, λ, and the ordinate is the optical effect, Pₒₚₜ. The transmission system based on the Hybrid CWDM-DWDM system technology has a number of optical transmission bands that are spread in a band of the optical spectrum. The third CWDM-channel λ₃ replaced by a number of DWDM-channels λ₅-λ₂₀.

The present invention is not limited to the above-described preferred embodiments. Various alternatives, modifications and equivalents may be used. Therefore, the above embodiments should not be taken as limiting the scope of the invention, which is defined by the appended claims.

1. Method for transmitting information over an optical communication system, which comprises a network having at least one optical fibre, wherein the total bandwidth of each fibre is divided into a number of wavelength bands, each wavelength band has a channel being able to carry information, characterised by following step:
transmitting information on a channel in one direction, while information on adjacent channels on the same fibre is transmitted in the opposite direction.

2. Method according to claim 1, characterised by the following step:
adding and/or dropping information on at least one channel by means of a counter-directional Optical Add Drop Multiplexer module.

3. Method according to claim 1, characterised in that the network comprises a second optical fibre that defines channels corresponding to the channels of a first optical fibre, thereby constituting a fibre pair, wherein the method comprises following step:
transmitting information in opposite direction on the corresponding channels of the first and second optical fibre.

4. Method according to claim 1, characterised in that the communication system is based on Coarse-Wavelength-Division-Multiplexing (CWDM) system technology.

5. Method according to claim 1, characterised in that the communication system is based on multiplexed logical ring structure technology.

6. Method according to claim 1, characterised in that the communication system is based on Coarse-Wavelength-Division-Multiplexing (CWDM) system and multiplexed logical ring structure technology.

7. An optical communication system, which comprises a network having at least one optical fibre, wherein the total bandwidth of each fibre is divided into a number of wavelength bands, each wavelength band has a channel being able to carry information, characterised in that channels are interleaved for counter-directional transmission, wherein information is transmitted on a channel in one direction, while information on adjacent channels on the same fibre is transmitted in the opposite direction.

8. An optical communication system according to claim 7, characterised in that the system comprises at least one counter-directional Optical Add Drop Multiplexer module being able to add and/or drop information on at least one channel.

9. An optical communication system according to claim 7, characterised in that the system is based on Coarse-Wavelength-Division-Multiplexing (CWDM) system technology and/or multiplexed logical ring structure technology.

10. An optical communication system according to claim 7, characterised in that the system is based on a Hybrid CWDM-DWDM system technology.

11. An optical communication system according to claim 7, characterised in that it comprises a second optical fibre that defines channels corresponding to the channels of the first optical fibre, and thereby constituting an optical fibre pair, but arranged for transmitting information in the opposite direction in relation thereto.

12. Use of a counter-directional Optical Add Drop Multiplexer module in an optical communication system, which comprises a network having at least one optical fibre, wherein the total bandwidth of each fibre is divided into a number of wavelength bands, each wavelength band has a channel being able to carry information, characterised in that channels are interleaved for counter-directional transmission, wherein information is transmitted on a channel in one direction, while information on adjacent channels on the same fibre is transmitted in the opposite direction.
